(19) United States
(12) Patent Application Publication
(10) Pub. No.: US 2006/0202959 A1
(43) Pub. Date: Sep. 14, 2006

(54) Rechargeable mouse holder

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,665

(22) Filed: Mar. 8, 2005

(51) Int. Cl. G09G 5/08

(52) U.S. Cl. 345/163

(57) ABSTRACT

A rechargeable mouse holder includes a housing, a first contact set and a second contact set. The housing has a mouse cavity and a battery cavity, the mouse cavity receives a rechargeable mouse therein, and the battery cavity receives a rechargeable battery therein; the first contact set is disposed in the housing, and includes a first anode contact and a first cathode contact extending into the mouse cavity; the second contact set is disposed in the housing, and has a second anode contact and a cathode contact extending into the battery cavity. Therefore, the holder can simultaneously recharge the mouse and the spare battery.

### BACKGROUND OF THE INVENTION

1. Field of the Invention

The present invention relates to a rechargeable mouse holder.

2. Description of Related Art

Computers and their various peripherals are broadly applied in modern life. For example, a mouse is a kind of peripheral for inputting information into a host device, while a display is another kind of peripheral for outputting information. The cursor shown and its motion on the display are controlled by the mouse, so the mouse is the foundation.

Conventional mice with cords include a base and a transmission wire having an end connecting with the base and another end connecting to the host. When moving the mouse, the transmission wire will often get the user's way. A wireless mouse overcomes this disadvantage. However, a battery is needed to provide power to the wireless mouse. This invention provides a rechargeable mouse holder developed for charging a wireless mouse.

With respect to FIG. 1, a conventional rechargeable mouse holder includes a housing 6 and a contact set 7. The housing 6 has a slot 61 for receiving a rechargeable mouse 91. The contact set 7 is disposed inside the housing 6. The contact set 7 includes an anode contact 71 and a cathode contact 72 protruding from the slot 61. The rechargeable mouse 91 has a rechargeable battery arranged inside and an anode pad and a cathode pad formed on a surface thereof. When the rechargeable mouse 91 is disposed inside the slot 61 of the housing 6, the anode pad and the cathode pad electrically connect with the anode contact 71 and the cathode contact 72, respectively. The rechargeable battery inside the mouse 91 can be recharged via the housing 6.

A conventional rechargeable holder only recharges the battery inside the mouse 91. When the mouse 91 is in use, the battery cannot be recharged simultaneously. That means if the battery of the mouse 91 runs out of power, it can no longer be used, causing inconvenience to the user. To avoid this, the user will need to have more batteries in case the one in use runs out of power, thereby increasing their costs. Furthermore, the battery is often easily lost due to its small size.

Hence, an improvement over the prior art is required to overcome the disadvantages thereof.

### SUMMARY OF THE INVENTION

The rechargeable mouse holder of the present invention can simultaneously recharge a mouse and a spare battery, in order to prevent any interruption of use due to power exhaustion.

The rechargeable mouse holder according to the present invention has multiple functions.

The rechargeable mouse holder includes a housing, a first contact set and a second contact set. The housing has a mouse cavity and a battery cavity, the mouse cavity receives a rechargeable mouse therein, and the battery cavity receives a rechargeable battery therein. The first contact set is disposed in the housing, and the first contact set includes a first anode contact and a first cathode contact extending into the mouse cavity. The second contact set is disposed in the housing, and has a second anode contact and a cathode contact extending into the battery cavity.

The mouse cavity and the battery cavity of the housing are used for the mouse and the battery respectively. Thus, the holder can simultaneously recharge a mouse and a spare battery. When the power of the mouse battery runs out, a spare battery can be provided immediately, so as to prevent any interruption in use.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of a conventional rechargeable mouse holder with a rechargeable mouse;

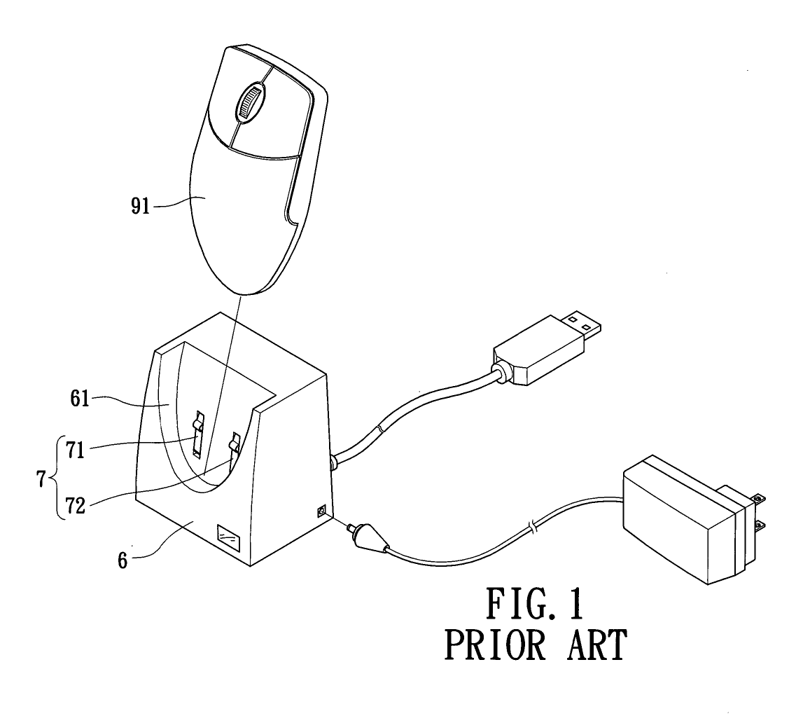

FIG. 2 is a perspective view of a rechargeable mouse holder according to the present invention;

FIG. 3 is a perspective view of the rechargeable mouse holder with a rechargeable battery according to the present invention; and

FIG. 4 is a perspective view of the rechargeable mouse holder recharging a rechargeable mouse and a rechargeable battery at the same time according to the present invention.

### DETAILED DESCRIPTION OF PREFERRED EMBODIMENTS

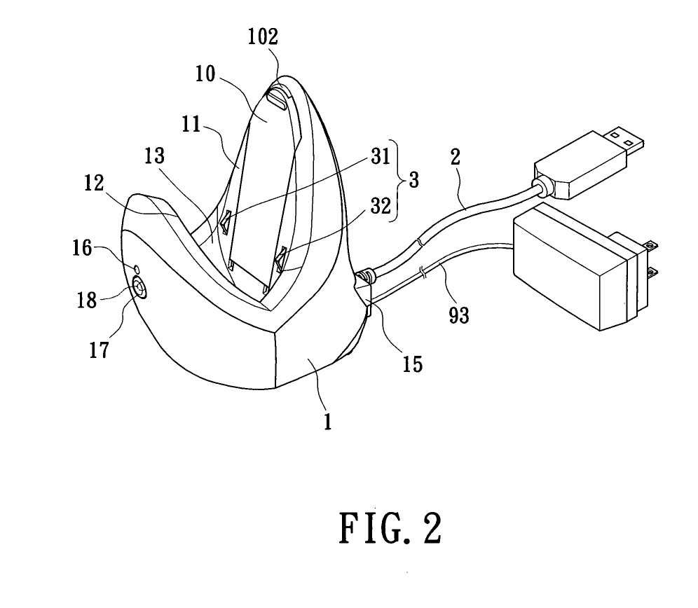

With respect to FIGS. 2 to 4, the rechargeable mouse holder includes a housing 1, a circuit board (not shown), a transmission wire 2, a first contact set 3 and a second contact set 4.

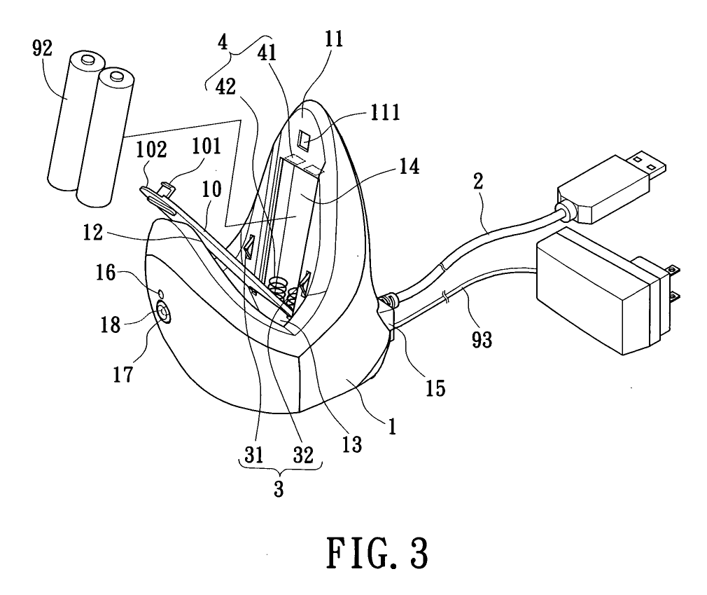

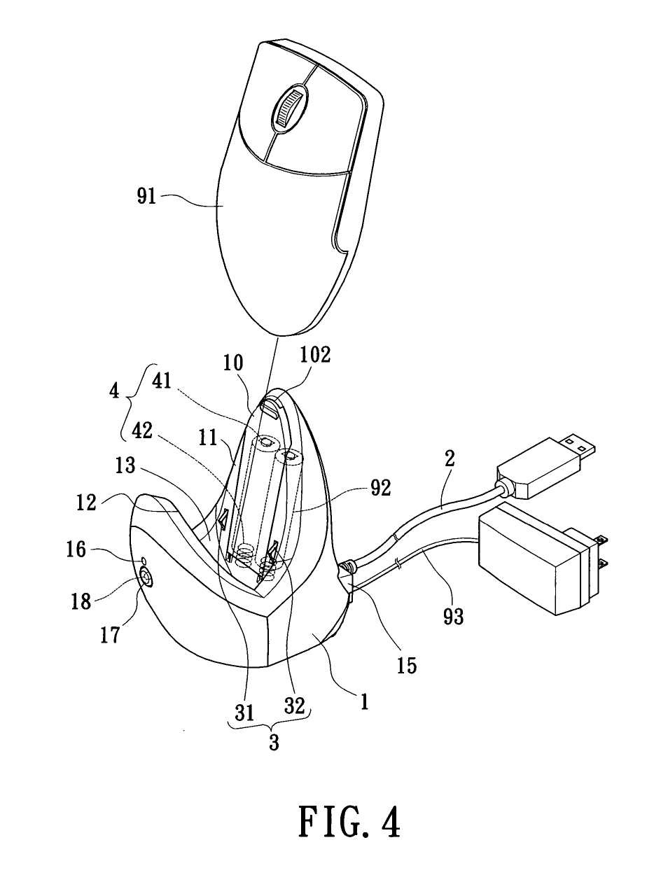

The housing 1 includes a first inner sidewall 11, a second inner sidewall 12, a mouse cavity 13 and a battery cavity 14. The mouse cavity 13 is formed between the first and the second sidewalls 11 and 12. Illustrated in FIG. 4, the mouse cavity 13 is used to receive a rechargeable mouse 91. The battery cavity 14 is formed on the first inner sidewall 11, and referring to FIG. 3, the battery cavity 14 is used to receive a rechargeable battery 92.

In accordance with this embodiment, the housing 1 further includes a lid 10. The lid 10 includes a hook arm 101; the first inner sidewall 11 of the housing 1 has a hook hole 111. The lid 10 has an edge pivotally connecting to the first inner sidewall 11, and another edge detachably clamping with the first inner sidewall 11 for allowing the lid 10 to be lifted to expose the battery cavity 14 to prevent dust and other foreign objects from entering. In addition, the lid 10 has a cutout 102 adjacent to the hook arm 101 so that the lid 10 can be easily lifted.

The circuit board is disposed inside the housing 1. The circuit board has recharge and over-charge protection circuits for recharging the mouse 91 and the battery 91. The circuit board includes a signal transmission circuit disposed thereon for setting the wireless connection between the holder and the mouse.

The housing 1 includes a power connection 15 for connecting with a power cord 93, in order to simultaneously recharge the mouse battery and the battery.

The housing 1 includes an indication light 16 to show the charged state of the battery 92 in the battery cavity 14, a signal transmission keystroke 17 disposed thereon for setting the wireless connection between the holder and the mouse 91, and a connection indication light 18 for displaying the connection state of the mouse 91.

The transmission wire 2 connects with the housing 1, one end thereof electrically connects with the signal transmission circuit of the circuit board, and an opposite end electrically connects with a host. The power connection 15 of the housing 1 and the power cord 93 connected thereto can be integrated into a power supply unit of the host and the transmission wire 2. The transmission wire 2 can electrically connect to the recharge and over-charge protection circuits.

The first contact set 3 is disposed inside the housing 1. The first contact set 3 includes a first anode contact 31 and a first cathode contact 32 for electrically connecting with the recharge and over-charge protection circuits and extending into the mouse cavity 13 for electrically connecting with the rechargeable mouse 91.

The second contact set 4 is disposed inside the housing 1. The second contact set 4 includes a second anode contact 41 and a second cathode contact 42 for electrically connecting with recharge and over-charge protection circuits and extending into the battery cavity 14 for electrically connecting to the rechargeable battery 92.

When the holder is in use, the transmission wire 2 connects to the host and the power cord 93 connects to an external power source. The rechargeable battery 92 is disposed inside the battery cavity 14. The battery 92 includes an anode pad (not shown) and a cathode pad (not shown) electrically connecting to the second anode contact 41 and the second cathode contact 42 respectively for recharging. While the mouse 91 is not in use, the mouse 91 can be received in the mouse cavity 13, and the mouse battery (inside the mouse 91) can electrically connect to the first anode contact 31 and the first cathode contact 32 via an anode pad (not shown) and a cathode pad of the mouse 91 for recharging. Therefore, the holder can recharge the mouse battery inside the mouse 91 and the rechargeable battery (spare one) in a simultaneous manner. When the mouse 91 is in use, the mouse battery thereof can provide the required power. When the mouse 91 is moved and operated, the connection indication light can show the state of the mouse 91. When the mouse battery has exhausted its power, the spare rechargeable battery 92, can be exchanged with the mouse battery.

The holder according to the present invention, is characterized by:

1. The mouse cavity and the battery cavity are used to receive the mouse and the battery therein respectively for recharging. Furthermore, when the mouse exhausts its power supply, its battery can be exchanged.

2. The holder can recharge the battery and the mouse at the same time, and can receive a signal from the mouse for multiple actions.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A rechargeable mouse holder comprising:
a housing having a mouse cavity and a battery cavity, the mouse cavity for receiving a rechargeable mouse therein, and the battery cavity for receiving a rechargeable battery therein;
a first contact set disposed in the housing, including a first anode contact and a first cathode contact extending into the mouse cavity; and
a second contact set disposed in the housing, having a second anode contact and a cathode contact extending into the battery cavity.

2. The rechargeable mouse holder as claimed in claim 1, wherein the housing has a first inner sidewall and a second inner sidewall, and the mouse cavity is formed between the first and the second inner sidewalls.

3. The rechargeable mouse holder as claimed in claim 2, wherein the battery cavity is formed in the first inner sidewall.

4. The rechargeable mouse holder as claimed in claim 3, wherein the housing includes a lid, which has an edge pivotally connecting to the first inner sidewall, and the lid has another edge detachably clamping with the first inner sidewall for allowing the lid to be lifted to expose the battery cavity.

5. The rechargeable mouse holder as claimed in claim 4, wherein the lid includes a hook arm, and the first inner sidewall of the housing has a hook hole corresponding to the hook arm.

6. The rechargeable mouse holder as claimed in claim 4, wherein the lid has a cutout.

7. The rechargeable mouse holder as claimed in claim 1, wherein the housing includes an indication light to show the recharging state of the battery in the battery cavity.

8. The rechargeable mouse holder as claimed in claim 1, wherein the housing includes a signal transmission keystroke disposed thereon for setting the wireless connection between the holder and the mouse.

9. The rechargeable mouse holder as claimed in claim 1, wherein the housing includes a connection indication light for displaying the connection state of the mouse.

10. The rechargeable mouse holder as claimed in claim 1, further including a transmission wire, in order to connect to the housing.

11. The rechargeable mouse holder as claimed in claim 1, wherein the housing has a power connection for connecting to a power cord.
